(19) United States
(12) Patent Application Publication
(10) Pub. No.: US 2012/0251124 A1
(43) Pub. Date: Oct. 4, 2012

(54) TRANSCEIVER FOR DIFFERENT VENDOR DEVICES

(76) Inventors: Winston Andrew Lewis, Springfield, MA (US); David L. McMullen, Groton, MA (US); Jerry Aguren, Tomball, TX (US)

(21) Appl. No.: 13/076,277

(22) Filed: Mar. 30, 2011

(51) Int. Cl. H04B 10/00

(52) U.S. Cl. 398/135

(57) ABSTRACT

A transceiver having an interface configured to communicate with a plurality of different vendor devices, non-volatile memory having a first memory block and a second memory block of memory, wherein the second memory block comprises a plurality of vendor device data corresponding to a plurality of different vendor devices which enable the transceiver to communicate with the vendor devices over the interface, and a controller configured to selectively copy one of the plurality of vendor device data from the second memory block to the first memory block, wherein copying enables the transceiver to communicate over the interface with a particular vendor device corresponding to the selected vendor device data.

### BACKGROUND

A transceiver can be any electronic device that includes both a transmitter and a receiver. Manufacturers or other organizations may collaborate to produce various standards for such electronic devices. These standards may set forth a wide range of design criteria for a device. The criteria may include physical, mechanical, and/or electrical specifications. In order to conform or comply with a standard, a device typically meets all of the called for physical, mechanical, and/or electrical provisions.

One organization that has been formed to set standards for the electronic storage industry is the Small Form Factor (SFF) Committee. The SFF committee may be found at http://www.sffcommittee.com. One set of standards set forth by the Committee includes standards for small form factor pluggable (SFP) transceivers. These standards include the Small Form Factor Pluggable Transceiver MultiSource Agreement (SFP MSA), the SFF-8074i Specification for SFP (Small Form Factor Pluggable) Transceiver (also referred to as INF-8074i), and the SFF-8472 Specification for Digital Diagnostic Monitoring Interface for Optical Transceivers.

A transceiver manufactured in accordance with these SFP standards includes non-volatile memory such as an Electrically Erasable Programmable Read-Only Memory (EEPROM) that is accessible by a vendor device coupled to the transceiver. The non-volatile memory may contain vendor device data that a vendor device can access for various purposes. The transceiver can provide an interface between a vendor device and a network communication channel. A vendor device can be any network device to provide access to a data or telecommunication network or communications channel.

### BRIEF DESCRIPTION OF THE DRAWINGS

FIG. 1 is a block diagram of a transceiver for different vendor devices in accordance with an embodiment of the invention.

FIG. 2 is a table of memory for use with the transceiver in accordance with an embodiment of the invention.

FIG. 3 is a flow chart illustrating a method of configuring a transceiver for operation with a particular vendor device in accordance with an embodiment of the invention.

FIG. 4 is a diagram illustrating a supply chain workflow for the transceiver for different vendor devices in accordance with an embodiment of the invention.

### DETAILED DESCRIPTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

A transceiver can provide an interface between a network communication channel and a vendor device. A transceiver can provide means for establishing communication for vendor devices. A vendor device can be any electronic network device or component that can operate within a network system to provide access to a data or telecommunication network or communications channel. For example, a vendor device can include network devices such as switches, routers, media converters or similar devices. In one example, a vendor device can be a Fibre Channel switch which can be configured to operate within a storage area network (SAN). The transceiver can be designed to support various communication channel protocols and standards such as synchronous optical networking (SON ET), Gigabit Ethernet, Fibre Channel, and other communications standards. A transceiver vendor can be any entity which can make a transceiver for use with vendor devices. A device vendor can be any entity which can make a vendor device. A transceiver can support communication speeds in the Gigabit per second (Gbs) range including 1 Gbs, 2 Gbs, 4 Gbs, 8 Gbs, 10 Gbs, and 16 Gbs. A transceiver can conform to SFP standards.

The use of such transceivers has evolved over the years. For example, initially, transceivers were generic and any transceiver, once installed into a network device would operate properly. Some transceivers employ a lock out mechanism which makes them operable only in vendor devices. One of the purposes of the lock out mechanism (such as lock codes or data) relates to market share and financial gain. The transceiver business enjoys large margins. Success in transceiver business may bring about two types of competition; the first is legitimate where other companies want to supply transceivers to the same customers as the network device companies. The second is criminal, where illicit entities may seek profits by selling counterfeit transceivers. The lock out mechanism may help address such situations. However, systems became more complex and different vendor devices entered the market. Device vendors began to customize transceivers for their own devices which reduced the ability of standard generic transceivers from working in any customer's device and set the stage for new vendors entering the market. The current trend is, as new device vendors enter the market, the transceivers are customized for their devices. Many transceivers configured with vendor data specific to a vendor data such as device lock out data which makes them operable only in those specific vendor devices.

The present application describes techniques which may help address this situation. Described is a transceiver that can operate and communicate with a plurality of different vendor devices. In one embodiment, described is a transceiver which can include an interface configured to communicate with a plurality of different vendor devices. For example, the transceiver may be agnostic in nature because it may be capable of operating with different vendor devices regardless or independent of the vendor or manufacturer of the device. The transceiver can include non-volatile memory having a first memory block and a second memory block, wherein the second block comprises a plurality of vendor device data corresponding to a plurality of different vendor devices which enable the transceiver to communicate with the vendor devices over the interface. The transceiver can selectively copy one of the plurality of vendor device data from the second block to the first block which enables the transceiver to communicate over the interface with a vendor device corresponding to the selected vendor device data. In one embodiment, the transceiver can disable communication with any of the plurality of vendor devices until the transceiver copies one of the vendor device data to the second memory block. In other words, a single transceiver can include a plurality of vendor device data to enable the transceiver to communicate with a plurality of different vendor devices. These techniques may provide one or more advantages such as, for example, helping to reduce the need for a plurality of unique and different transceivers from transceiver vendors by providing a single transceiver. These single transceivers may include identical functionalities as the plurality of transceiver produced to be compatible for the various vendor devices. These techniques may provide a single transceiver which can help meet all the functional requirements of existing transceivers.

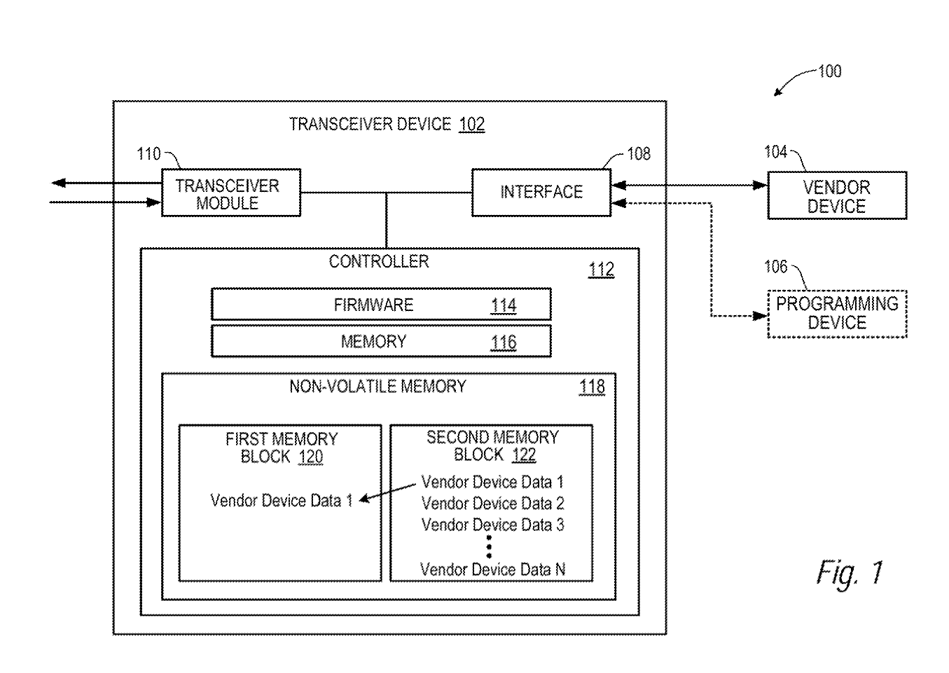

FIG. 1 is a block diagram illustrating an embodiment of a system 100 that includes a transceiver 102 configured to communicate with a plurality of vendor devices such as vendor device 104. As shown in FIG. 1, vendor device 104 is coupled to transceiver 102. A single vendor device 104 is shown for simplicity but it should be understood that the transceiver can be configured to communicate with a plurality of different vendor devices. Transceiver 102 includes a transceiver module 110, a controller 112, and an interface 108. The controller 112 includes firmware 114, memory 116, and non-volatile memory 118. A programming device 106 can be coupled to interface 108 to allow transceiver 102 to be configured to operate with a particular vendor device as explained below in further detail.

The vendor device 104 may include a wired or wireless device configured to operate in conjunction with transceiver 102. The vendor device 104 may be external to transceiver 102. Examples of such devices can include a test system, a server computer system, a personal computer system, a laptop computer system, a handheld computer system, a personal digital assistant, a mobile telephone and the like. Other examples of such vendor devices can include communication components directed to different communication technologies such as Ethernet and Fibre Channel, different communication functions such as switches, routers and the like.

The transceiver 102 can comprise an optical transceiver configured to communicate with vendor device 104 by sending and receiving electrical signals as described in additional detail herein below. The transceiver 102 can also communicate with another-device (not shown) by sending and receiving optical signals using transceiver module 110. The transceiver module 110 can include an optical interface which may be a Fibre Channel interface or another type of optical interface.

In one embodiment, transceiver 102 can conform to the Small Form Factor Pluggable Transceiver MultiSource Agreement (SFP MSA), the SFF-8074i Specification for SFP (Small Form Factor Pluggable) Transceiver (also referred to as INF-8074i), and the SFF-8472 Specification for Digital Diagnostic Monitoring Interface for Optical Transceivers. The SFP MSA, the SFF-8074i specification, and the SFF-8472 specification are available from http://www.sffcommittee.com or ftp://ftp.seagate.com/sff/, all of which are incorporated herein by reference. In other embodiments, transceiver 102 may conform to other specifications.

In some embodiments, the data flow may not include analog-to-digital or digital-to-analog functionality. In other embodiments, there may be analog-to-digital conversion functionality to read the laser optical power output and received optical power of a PIN Diode. The electrical signals received and transmitted from a transceiver may be digital. The optical transmit and receive signals may be both digital. The laser driver of the SFP may convert the received signal entering the SFP on the transmit side to the appropriate signal and bias required to make the laser operate. The transceiver module 110 can include a transmitter such as an optical transmitter configured to receive digital output signals from vendor device 104 through interface 108. The transceiver module 110 can include a digital-to-analog converter to convert the digital output signals to analog output signals and provide the analog output signals to a laser. The digital output signals and the analog output signals comprise electrical signals. The laser can generate optical output signals in response to the analog output signals and provide the optical output signals to transceiver module 110.

The transceiver module 110 can include a receiver which can comprise an optical receiver configured to receive optical input signals from transceiver module. The transceiver module 110 can include an analog-to digital converter to convert the optical input signals from analog input signals to digital input signals and provide the digital input signals to vendor device 104 through interface 108. The digital output signals and the analog output signals comprise electrical signals.

The transceiver 102 can also communicate with vendor device 104 through interface 108. In particular, transceiver 102 can receive control signals from vendor device 104 through interface 108. The transceiver 102 can also provide information to vendor device 104 through interface 108. In one embodiment, interface 108 couples vendor device 104 to transceiver 102 and may be any suitable serial or parallel connection. One suitable connection would be an I2C connection, as provided by the I2C-Bus Specification available from Philips Semiconductors. In embodiments where interface 108 is an I2C connection, the interface can include I2C bus interface. The interface 108 may comprise any hardware or a combination of hardware and software components.

The controller 112 includes firmware 114 comprising instructions and data that is executable by controller 112 to cause control signals to be generated and feedback signals to be received and processed for operation of transceiver. The memory 116 can store data for the operation of transceiver 102. The memory may be any type or combination of volatile and non-volatile storage including registers, flash memory, or RAM. In other embodiments, controller 112 may use other combinations of hardware and/or firmware or software to perform the functions described herein.

The non-volatile memory 118 can comprise any type of non-volatile memory such as EEPROM. The non-volatile memory 118 is shown in FIG. 1 as included as part of controller 112. In other embodiments, non-volatile memory 118 may be located separate from (i.e. not included in) controller 112 and/or may be included in other components of transceiver 102. Information storable in non-volatile memory 118 may be defined by the SFP MSA, the SFF-8074i specification, and the SFF-8472 specification referenced above.

In the embodiment of FIG. 1, non-volatile memory 118 is shown as including a first memory block 120 and a second memory block 122. The second block 120 includes a plurality of vendor device data corresponding to a plurality of vendor devices. For example, FIG. 1 shows second memory block 122 with vendor device data that includes three unique sets of vendor device data (vendor device data 1, vendor device data 2, vendor device data 3) corresponding to three different vendor devices. It should be understood that the three sets of vendor device data is shown for illustrative purposes and that a different number of vendor device data can be employed. The first memory block 120 is shown having vendor device data 1 which was copied from second memory block 122. As explained below, first memory block 120 may be initially configured with no vendor data and which prevents the transceiver from communicating with any vendor device until the transceiver is configured to operate with one of the vendor devices. In one embodiment, programming device 106 can be used to configure transceiver 102 by selectively copying one of the plurality of vendor data from second block 122 to first memory block 120. This would enable communication between the transceiver 102 and a vendor device corresponding to the select vendor data. Programming device 106 can be any electronic device configured to access non-volatile memory 118 using any protocol for reading and writing data such as an I2C protocol. For example, programming device 106 can cause controller 112 to selectively copy one particular set of vendor device data, such as vendor device data 1, from second block 122 to first block 120, as shown in FIG. 1. This would enable transceiver 102 to communicate and operate properly with a vendor device corresponding to vendor device data 1, as explained below in further detail. FIG. 1 shows vendor device data 1 copied from second memory block 122 to first memory block 120 for illustrative purpose and it should be understood that any other vendor device data can be copied to second memory block.

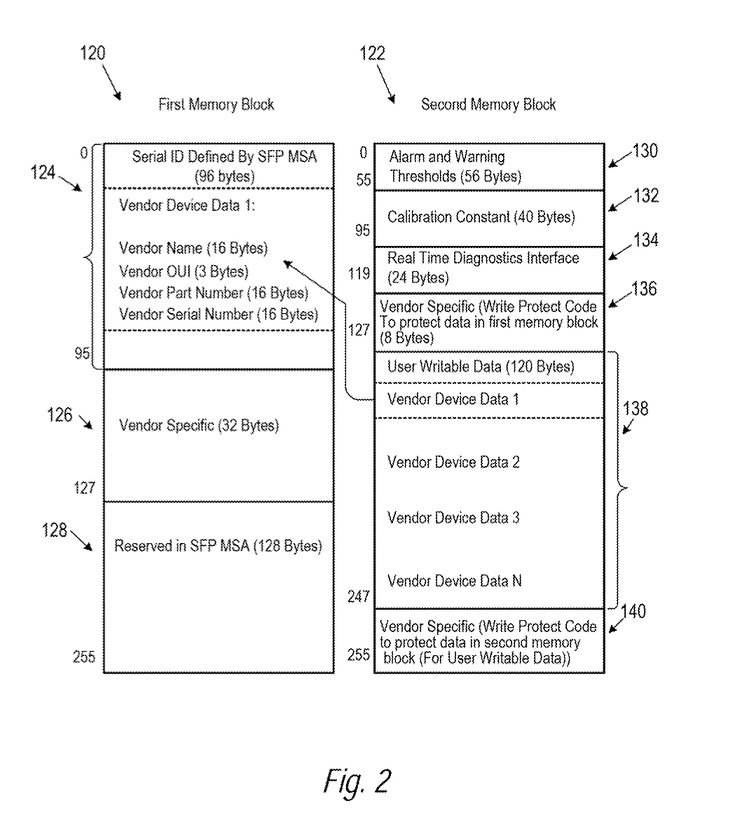

FIG. 2 is a table illustrating an embodiment of first memory block 120 and second memory block 122 for use in the transceiver of FIG. 1. The first memory block 120 is stored in non-volatile memory 118 and is accessed by transceiver 102 using a device address of A0h. The first memory block 120 includes 256 bytes of information where bytes 0 through 95 are for serial identification information as defined by the SFP MSA as indicated by a block 124, bytes 96 through 127 are for vendor specific information as indicated by a block 126, and bytes 128 through 255 are reserved by the SFP MSA as indicated by a block 128.

The second memory block 122 is stored in non-volatile memory 118 and is accessed by transceiver 102 using a device address of A2h. The second memory block 122 includes 256 bytes of information where bytes 0 through 55 are for alarm and warnings thresholds information as indicated by a block 130, bytes 56 through 95 are for calibration constants as indicated by a block 132, bytes 96 through 119 are for real time diagnostic interface information as indicated by a block 134, bytes 120 through 127 are for vendor specific information as indicated by a block 136, bytes 128 through 247 are for a user writable non-volatile memory as indicated by block 138, and bytes 248 through 255 are for vendor specific information as indicated by a block 140. The vendor specific information indicated by block 140 can be used to store a password which can be used to protect the data in the user writable area as indicated by block 138. In a similar manner, the vendor specific information indicated by block 136 can be used to store a password which can be used to protect the data in vendor device data as indicated by block 124.

In accordance with an embodiment of the invention, serial identification information block 124 is initially populated with no information or vendor data relating to a vendor device. This configuration is in contrast to the SFP standard which specifies that serial identification information block 124 is to be populated with vendor device data corresponding to a particular vendor device. Further the SFP standard does not specify data or information that is to be stored in user writable data as indicate by block 138. In accordance with an embodiment of the invention, a plurality of unique vendor device data corresponding to a plurality of vendor devices is stored in user writable data block 138. FIG. 2 shows the state of first memory block 120 after vendor device data 1 was copied from second memory block 122 to first memory block 120. The vendor data may include unique data corresponding to a particular vendor device such as device vendor lock out data. A vendor device may be configured to communicate with the transceiver only if the transceiver has vendor lock out data in first memory block 120. That is, without the vendor lock out data, the transceiver may be “locked out” or prevented from communicating with the particular vendor device. The vendor device lock out data may include the following: device vendor name consisting of 16 bytes starting at byte 14 hex of first memory block 120, device vendor organizationally unique identifier (OUI) consisting of 3 bytes starting at byte 25 hex of first memory block 120, device vendor part number consisting of 16 bytes starting byte 28 hex of first memory block 120, device vendor serial number consisting of 16 bytes starting at 44 hex. In one embodiment, the device vendor lock out data may be unique to a particular vendor device and configured to only be compatible with a particular vendor device. FIG. 2 shows vendor device data 1 as being selected to be copied to first memory block 120 only for illustrative purpose and it should be understood that any of the other vendor device data, such as vendor device data 2 or vendor device data 3 could have been selected to be copied to first memory block 120.

Additional details regarding the each of the blocks in memory maps 120 and 122 shown in FIG. 2 may be found in the SFP MSA, the SFF-8074i specification, and the SFF-8472 specification referenced above. In other embodiments, transceiver 102 may store memory maps other than those shown in FIG. 2.

As described by the SFP MSA, the SFF-8074i specification, and the SFF-8472 specification, transceiver 102 may be configured to provide transceiver 102 with an ability to read information from and write information to non-volatile memory 118. The transceiver 102 can perform these functions using controller 112, interface 108 and non-volatile memory 118. In particular, controller 112 can cause information to be copied from second memory block 122 to first memory block 120 in response to requests for commands received over interface 108. For example, programming device 106 can be coupled to transceiver 102 and configured send commands to cause controller 112 to copy information or data from second memory block 122 to first memory block 120. Programming device 106 can also be configured to send commands to cause controller 112 to read information or data from second memory block 122 or first memory block 120. Additional details of the operation of transceiver 102 and non-volatile memory 1′18 is described below.

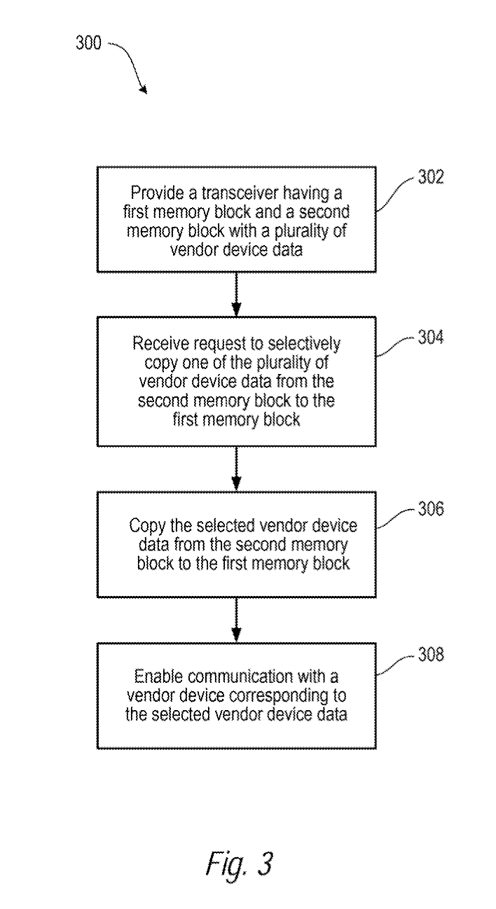

FIG. 3 is flow chart 300 illustrating a method of configuring a transceiver for operation with a particular vendor device in accordance with an embodiment of the invention. The embodiment of the method of FIG. 3 will be described with reference to FIG. 1. To illustrate, it will be assumed that transceiver 102 is configured to have no vendor data (blank) in first memory block 120 and a plurality of vendor data stored in second memory block 122, as indicated in method block 302. For example, a manufacture of a transceiver, such as a transceiver vendor, can manufacture and configure transceiver 102 by storing a plurality of vendor device data in second memory block 122 and storing no vendor data in first memory block 120. This may allow the transceiver vendor to provide a single transceiver capable of operating with a plurality of vendor devices. This technique may help reduce the need for the transceiver vendor from having to provide a transceiver device for each vendor device. To illustrate, it will be further assumed that the plurality of vendor device data includes vendor device data for three different and unique vendor devices (vendor device data 1, vendor device data 2 and vendor device data 3). In accordance with an embodiment of the present invention, the transceiver vendor can then supply the transceiver with a plurality of vendor device data to a separate entity such as a technology company that can then configure the transceiver for a particular vendor device, as explained below at method block 304.

At block 304, transceiver 102 receives a request to selectively copy one of the plurality of vendor data from second memory block 122 to first memory block 120. For example, the technology company can configure the transceiver that was provided by the transceiver vendor. To illustrate, the technology company can receive from an external customer a request to configure the transceiver for a particular vendor device. The transceiver can be part of a storage system that is compatible with the particular vendor device. For example, it can be assumed that the vendor device corresponds to vendor device data 1.

At block 306, transceiver 102 copies the selected vendor device data from second memory block 122 to first memory block 120. Continuing with the above example, the technology company can proceed to configure the transceiver in accordance with the customer's request. That is, in this case, the transceiver can be programmed to operate with the vendor device corresponding to vendor device data 1. To program the transceiver, the technology company can begin by coupling programming device 106 to transceiver 102 and then proceed configuring the programming device to cause the transceiver to copy the selected vendor device data from second memory block 122 to first memory block 120. For example, in this case, controller 112 can copy vendor device data 1 from second memory block 122 to first memory block 120.

At block 308, transceiver 102 enables communication with a vendor device corresponding to the selected vendor device data. The programming device 106 can also be used to verify that the data was written correctly onto first memory block 120. For example, this verification can also help ensure that the newly written vendor device data can be read from the transceiver when it is subsequently coupled with the particular vendor device during power up and initialization. For example, the functionality of transceiver 102 can be checked whether it conforms to Fibre Channel SFP standard operation. The technology company can then provide the transceiver configured to operate with a particular vendor device to the customer. The customer can then install the transceiver into their system which includes the compatible vendor device. In some embodiments, transceiver 102 may only be able to operate with the selected vendor device corresponding to the selected vendor device data (vendor device data 1), and may not be able to operate or communicate properly with a different vendor device.

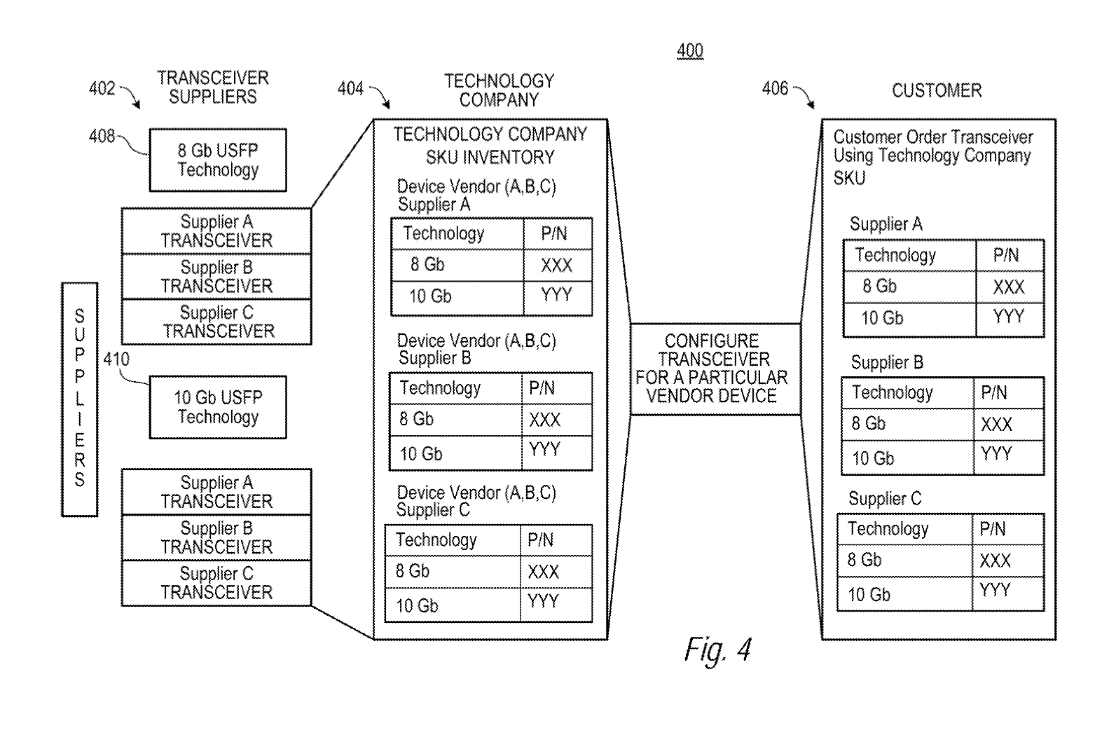

FIG. 4 is a diagram illustrating a supply chain workflow 400 for a transceiver for different vendor devices in accordance with an embodiment of the invention. As explained above, in one embodiment of the invention, disclosed is a single transceiver that can be configured to operate and communicate with a plurality of vendor devices. This technique may provide one or more advantages as it relates to supply chain workflow as explained below in further detail.

To illustrate, it will be assumed that supply chain workflow 400 comprises, starting at the supplier side, a plurality of transceiver suppliers 402 that provide or manufacture transceivers in accordance with different technologies. The transceiver suppliers 402, in turn, can provide the transceivers to a technology company 404 which can configure or program the transceivers according to the requirements of a customer 406.

The transceiver suppliers 402 can provide various types of transceivers. For example, transceiver suppliers 402 can provide and manufacture optical technology transceivers according to various data rates and wavelengths. The data rates can include 1 Gb, 2 Gb, 4 Gb, 8 Gb, 10 Gb and future rates such as 16 Gb. For each data rate, there can be two corresponding wavelengths, namely short wave (SW) and long wave (LW). To illustrate, it will be assumed that there are three transceiver suppliers of transceivers: Supplier A, Supplier B and Supplier C. In addition, it will be assumed that there are two transceiver technologies, namely, 8 Gb Technology (as indicated by arrow 408) and 10 Gb Technology (as indicated by arrow 410).

As shown in FIG. 4, transceiver suppliers 402 can provide to technology company 404 a transceiver with a single part reference number, such as stock-keeping unit (SKU), for each technology that can operate with a plurality of vendor devices. For example, Supplier A can provide a single transceiver for 8 Gb technology that can operate with three vendor devices (A, B, C). That is, the transceiver can contain the specific lock out data for three vendor devices. The customer 406 can request from technology company 404 a transceiver for a particular vendor device. The technology can now simply configure the transceiver to operate with the particular vendor device, as explained above. The transceiver provided by Supplier A can have one single SKU. The use of a single SKU can help reduce the complexity of part number management between transceiver suppliers 402 and technology company 404. That is, a single part number per transceiver can replace otherwise multiple part numbers between suppliers and technology company. Further, this technique may result in only one part reference number for a specific transceiver technology to be maintained by each technology vendor regardless of the device vendor.

The components of the transceiver described in the present application can be implemented with machine-readable instructions that can be loaded for execution on processor(s). A processor can include a microprocessor, microcontroller, processor module or subsystem, programmable integrated circuit, programmable gate array, or another control or computing device.

Data and instructions can be stored in storage devices, which can be implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

Further, the components shown and described in this application may also be implemented in program code (e.g., firmware and/or software and/or other logic instructions) stored on one or more computer readable medium and executable by one or more processors to perform the operations described in this application. The components are merely examples of various functionality that may be provided, and are not intended to be limiting. The embodiments shown and described are provided for purposes of illustration and are not intended to be limiting.

1. A transceiver comprising:
an interface configured to communicate with a plurality of different vendor devices;
non-volatile memory having a first memory block and a second memory block of memory, wherein the second memory block comprises a plurality of vendor device data corresponding to a plurality of different vendor devices which enable the transceiver to communicate with the vendor devices over the interface; and
a controller configured to selectively copy one of the plurality of vendor device data from the second memory block to the first memory block, wherein copying enables the transceiver to communicate over the interface with a particular vendor device corresponding to the selected vendor device data.

2. The transceiver of claim 1, wherein the transceiver conforms to the small form factor pluggable transceiver multi-source agreement (SFP MSA).

3. The transceiver of claim 1, wherein the interface is configured to receive a request from a programming device to cause the controller to selectively copy one of the plurality of vendor device data from the second memory block to the first memory block.

4. The transceiver of claim 1, wherein the transceiver is configured to provide an interface between a network communication channel and a vendor device for communication over the communication channel.

5. The transceiver of claim 1, wherein the transceiver is configured to receive a request from the vendor device corresponding to the selected vendor device data to read the vendor device data stored on the first memory block.

6. The transceiver of claim 1, wherein the plurality of vendor device data includes vendor device lockout data unique to a particular vendor device from the plurality of vendor devices and which will allow communication only with the particular vendor device.

7. The transceiver of claim 1, wherein the transceiver is configured to receive electrical signals from the vendor device corresponding to the selected vendor device data and generate optical signals in response to the electrical signals.

8. The transceiver of claim 1, wherein the transceiver disables communication with any of the plurality of vendor devices until the transceiver selectively copies one of the plurality of vendor device data from the second memory block to the first memory block.

9. A method of configuring a transceiver having an interface configured to communicate with a plurality of different vendor devices and having non-volatile memory comprising a first memory block and a second memory block, wherein the second memory block comprises a plurality of vendor device data corresponding to plurality of different vendor devices which enable the transceiver to communicate with the vendor devices over the interface, the method comprising:
receiving a request to selectively copy one of the plurality of vendor device data from the second memory block to the first memory block;
copying the selected vendor device data from the second memory block to the first memory block; and
enabling the transceiver to communicate over the interface with a particular vendor device corresponding to the selected vendor device data.

10. The method of claim 9, wherein the transceiver conforms to the small form factor pluggable transceiver multi-source agreement (SFP MSA).

11. The method of claim 9, further configuring the interface for receiving a request from a programming device to cause the controller to selectively copy one of the plurality of vendor device data from the second memory block to the first memory block.

12. The method of claim 9, wherein copying causes the transceiver to disable communication with a vendor device that does not correspond to the selected vendor device data.

13. The method of claim 9, wherein the transceiver is configured to receive a request from the vendor device corresponding to the selected vendor device data to read the vendor device data stored on the first memory block.

14. The method of claim 9, wherein the plurality of vendor device data includes vendor device lockout data unique to a particular vendor device from the plurality of vendor devices and which will allow communication only with the particular vendor device.

15. The method of claim 9, wherein a single part reference number is assigned to the transceiver which is configured to communicate with a plurality of different vendor devices.

16. A system comprising:
a vendor device associated with vendor data and configured to communicate with a transceiver having the vendor device data; and
a transceiver with non-volatile memory having a first memory block and a second memory block, wherein the second memory block comprises a plurality of vendor device data corresponding to plurality of different vendor devices, and a controller configured to selectively copy one of the plurality of vendor device data from the second memory block to the first memory block, wherein copying enables communication with a vendor device corresponding to the selected vendor device data.

17. The system of claim 16, wherein the transceiver conforms to the small form factor pluggable transceiver multi-source agreement (SFP MSA).

18. The system of claim 16, wherein the plurality of vendor device data includes vendor device lockout data unique to a particular vendor device from the plurality of vendor devices and which will allow communication only with the particular vendor device.

19. The system of claim 16, wherein the transceiver is configured to receive electrical signals from the selected vendor device and generate optical signals in response to the electrical signals.

20. The system of claim 16, wherein the transceiver is configured to receive a request from the vendor device corresponding to the selected vendor device out data to read the vendor device data stored on the first memory block.
